(19) United States
(12) Patent Application Publication
(10) Pub. No.: US 2013/0077014 A1
(43) Pub. Date: Mar. 28, 2013

(54) LED Backlight Module and Liquid Crystal Display Device

(71) Applicant: Ruìlían Yang, Shenzhen (CN)

(72) Inventor: Ruìlían Yang, Shenzhen (CN)

(73) Assignee: Shenzhen China Star Optoelectronics Technology Co., Ltd., Shenzhen, Guangdong (CN)

(21) Appl. No.: 13/319,434

(22) PCT Filed: Oct. 12, 2011
(86) PCT No.: PCT/CN2011/080716

§ 371 Date: Nov. 8, 2011

(30) Foreign Application Priority Data
Sep. 28, 2011 (CN) 201110300207.7

(51) Int. Cl. G09F 13/04; G02F 1/13357

(52) U.S. Cl. 349/58; 362/97.1

(57) ABSTRACT

The present invention discloses a LED backlight module and a LCD device; the LED backlight module comprises a lamp source fixing device for fixing the LED light bar and a backplane connected to the lamp source fixing device, wherein said lamp source fixing device is connected with said backplane from the outer layer of the LED backlight module. The present invention has the advantages that the LED removal process is greatly simplified; the LEDs in the structure are disassembled without moving the optical part; the phenomenon that the optical part is artificially damaged is avoided; and there is less possibility that movement affects and reduces the quality of display.

### TECHNICAL FIELD

The present invention relates to the field of displays, particularly to a light emitting diode (LED) backlight module and a liquid crystal display (LCD) device.

### BACKGROUND

The use of light-emitting diode as a backlight source at present becomes the market trend, and the use is widely observed in the field of LCDs. The structure of the existing LCD device using the LED backlight module is shown in FIG. 1. The outermost layer of the LCD device comprises a front frame, then a rubber frame, a backplane, and an aluminum extrusion respectively from the outside to the inside when being seen from one side, and then printed circuit board (PCB) and LEDs which form the LED light bar. Because the existing LEDs are positioned on the innermost part of the whole backlight module, if individual LEDs are burned out and are reworked, the LEDs can be removed only when the front is removed, and components including the glass, the optical diaphragm, the light guiding plate (LGP) and the like are taken out. Thus, man-hour is wasted in the process.

### SUMMARY

The aim of the present invention is to provide a LED backlight module and a LCD device thereof for removing LEDs conveniently.

The purpose of the present invention is achieved by the following technical schemes.

A LED backlight module comprises a lamp source fixing device, and a backplane connected with the lamp source fixing device, wherein said lamp source fixing device is positioned on the outermost layer of said LED backlight module and is fixed on the outside of said backplane.

Preferably, said backplane is provided with one or more convex prismatical threaded holes; said lamp source fixing device is provided with one or more via holes matched with said convex prismatical threaded hole; and said lamp source fixing device is fixedly connected with said backplane on one side of said lamp source fixing device by one or more screws via the threaded hole through the via hole. In the fixing mode, because the threaded hole of the backplane is convex, the inner wall of the hole can be provided with more threads, and the screw can be firmly screwed in the threaded hole.

Preferably, said lamp source fixing device is made of aluminum extrusion. The lamp source fixing device made of metal material can also perform the heat dissipation function when effectively fixing the LED light bar; the aluminum extrusion has the advantages of moderate price, light weight, good heat dispersion and high cost performance.

A LCD device comprises a LCD panel, a backlight module, and a front frame for fixing said LCD panel and said backlight module, wherein said backlight module is the aforementioned LED backlight module.

Preferably, said front frame is fixedly connected with said lamp source fixing device. The existing LCD device, when being seen from the outside to the inside from one side, comprises a front frame, a rubber frame, a backplane, and a lamp source fixing device, namely a structure of four layers in total; while in the embodiment, the front frame is directly and fixedly connected with the lamp source fixing device, the rubber frame is directly omitted, and the backplane is fixedly connected with the lamp source fixing device on the back of the LED backlight module without being extended to the side of the LED backlight module for being fixed. Therefore, the embodiment can reduce the cost on the one hand, and can reduce the width of the frame of the LCD device on the other hand to accord with the trend of light-weight and thin LCD device. In order to increase the generality of the components, said front frame and said lamp source fixing device can be fixed by one or more screws as the fixing mode of said lamp source fixing device and said backplane.

Preferably, said LCD device comprises a reflection sheet, a light guide plate (LGP), and an optical diaphragm which are sequentially arranged above said backplane; wherein said LCD panel is positioned above the light emergent surface of the optical diaphragm; one end of said lamp source fixing device for fixing the LED light bar is positioned on one side of said LGP, and a positioning plate is arranged between the upper part of the end and the LCD panel; said positioning plate comprises a first end arranged between the side of the LCD panel and the front frame. The clamping force is increased by the positioning plate to said LCD panel, and the side of the LCD panel is limited by the first end.

Preferably, the surface of said positioning plate which is in contact with said LCD panel is provided with a buffer material. The buffer material is added on the side and the bottom of the LCD panel so that preferable clamping force is brought to the LCD panel and the LCD panel resists being crushed to pieces. In addition, the buffer material added to the bottom (namely one side of the LCD panel facing the LGP) of the LCD panel can also perform the function of shading light by reducing the light leakage of LED light source, and the function of further increasing the light incidence rate in addition to increasing the clamping force. Said buffer material can be rubber materials and the like which have certain elastic deformation.

Preferably, a second end is arranged between said LED light bar and said LGP, and one side of said second end is in contact with the light incident surface of said LGP. The second end is butted with the light incident surface of the LGP so that one or more LEDs can be prevented from being extruded and damaged when the LGP is expanded by heat.

Preferably, said LED is in contact with the light incident surface of said LGP. Because the second end is butted with the light incident surface of the LGP, the LED is not extruded and damaged when the LGP is expanded by heat. The technical scheme can reduce the light coupling distance between the LED and the LGP, and even can achieve the zero light coupling distance so that the light incidence rate of the LGP is maximized and the light mixing distance of the LED is guaranteed. Preferably, the surface of said second end which is in contact with said LGP is provided with a buffer material. The buffer material can buffer the extruding force of the second end to the LGP, and reduce the possibility that the LGP is extruded and damaged.

By research, the inventor finds that the existing LEDs are fixed on the lamp source fixing device; the lamp source fixing device is positioned inside the backlight module, and the outside is surrounded by the backplane from the side to the bottom. Therefore, the LEDs can be removed by only removing the components from the outside to the inside during LED removal. In the present invention, the lamp source fixing device is arranged on the outside of the backlight module, the backplane is arranged inside the backlight module, and the lamp source fixing device is fixedly connected with the backplane. Thus, the stability of the structure is not affected; the lamp source fixing device is directly taken out as long as the front frame is removed first and then the lamp source fixing device is disconnected from the backplane during removal; the LED removal process is greatly simplified; the phenomenon that the optical part is artificially damaged is avoided because the LEDs in the structure are removed without moving the optical part; and there is less possibility that movement affect and reduces the quality of display.

### BRIEF DESCRIPTION OF FIGURES

FIG. 1 is the structural diagram of the LCD device of the prior art;

FIG. 2 is the amplified schematic diagram of one embodiment of the present invention;

FIG. 3 is the schematic diagram of one embodiment of the present invention;

FIG. 4 is the amplified schematic diagram of the other embodiment of the present invention; and

FIG. 5 is the schematic diagram of one embodiment of the present invention.

Wherein: 1. buffer material; 2. backplane; 3. front frame; 4, PCB; 5, LED; 6. lamp source fixing device; 71. reflection sheet; 72. LGP; 73. optical diaphragm; 8. positioning plate; 81. the first end; 82. the second end; 9. LCD panel; 10. rubber frame; 11. screw.

### DETAILED DESCRIPTION

The present invention will further be described in detail in accordance with the figures and the preferred embodiments.

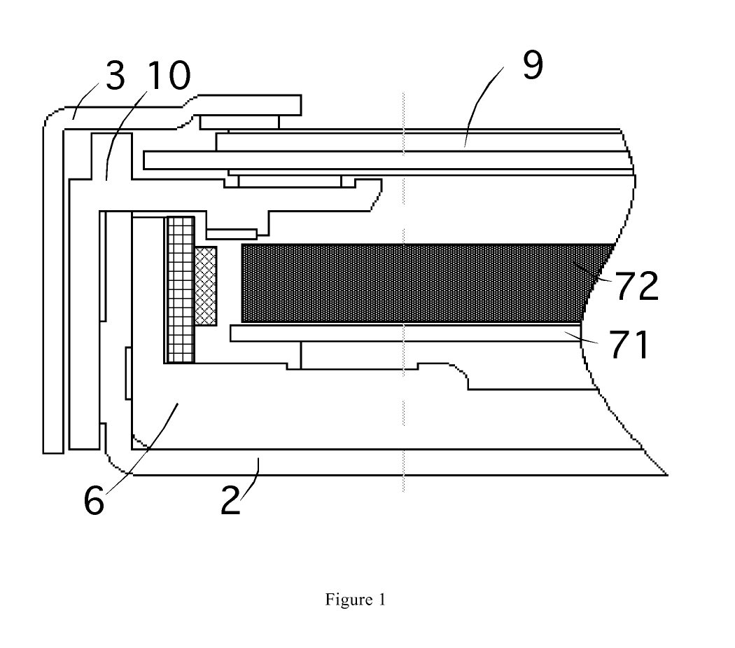

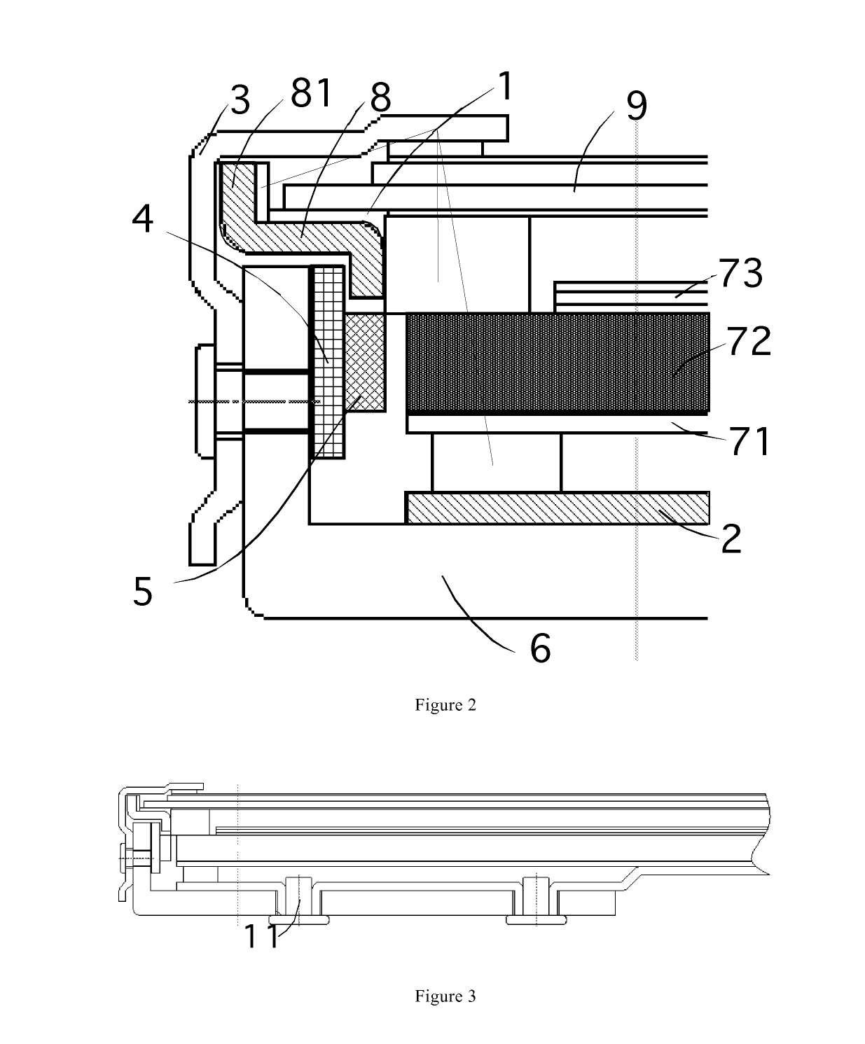

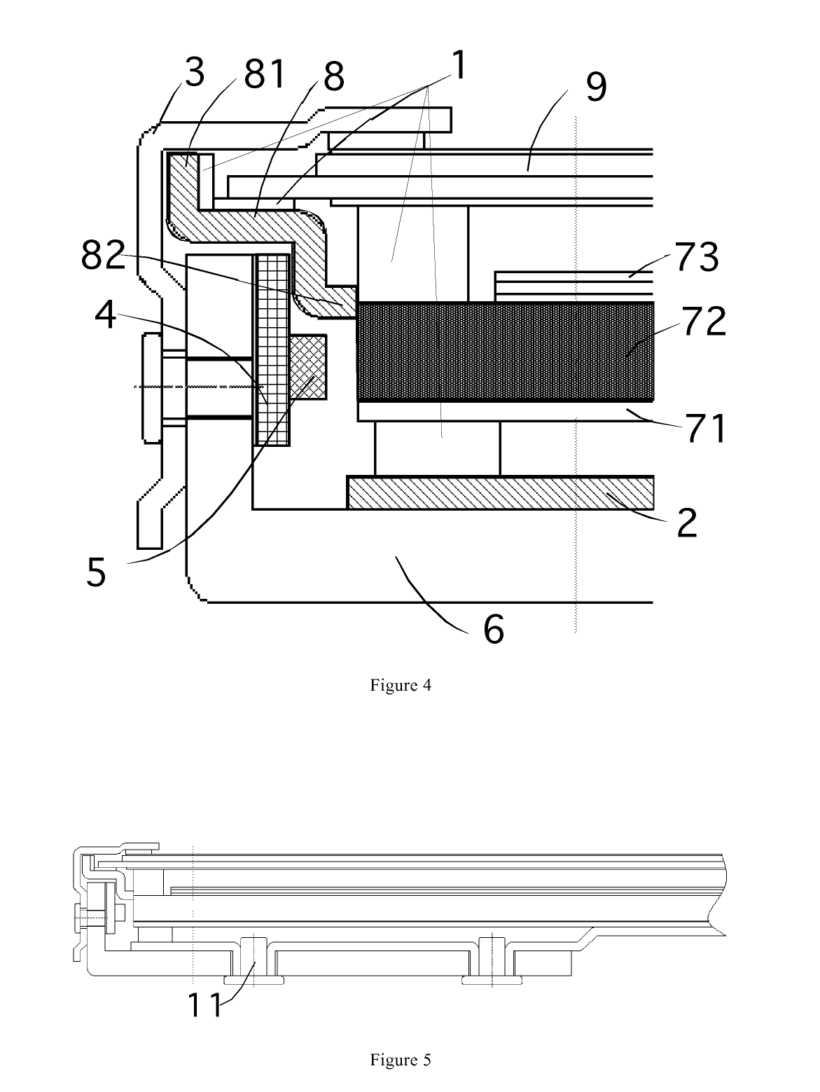

As shown in FIG. 1 and FIG. 2, a LCD device comprises a LED backlight module. Said LED backlight module comprises a lamp source fixing device 6 for fixing the light bar of LED 5, and a backplane 2 connected with the lamp source fixing device 6; wherein said LED 5 light bar comprises LED 5 and PCB 4 which is used for fixing the LED 5 and supplying power for the LED 5; and said PCB 4 is fixed on the lamp source fixing device 6. Said lamp source fixing device 6 is positioned on the outermost layer of said LED backlight module and is fixed on the outside of said backplane 2; and said backplane 2 is positioned inside the LED backlight module. Said LCD device comprises a reflection sheet 71, a light guide plate (LGP) 72, an optical diaphragm 73, and a LCD 9 which are sequentially arranged above said backplane 2. The invention will further be described in detail in accordance the embodiments.

Embodiment 1.

The backlight module and the LCD panel are fixed by the front frame 3; preferably, the front frame 3 is fixedly connected with said lamp source fixing device 6. The existing LCD device, when being seen from the outside to the inside from one side, comprises a front frame 3, a rubber frame 10, a backplane 2, and a lamp source fixing device 6, namely a structure of four layers in total; while in the embodiment, the front frame 3 is directly and fixedly connected with the lamp source fixing device 6, the rubber frame 10 is directly omitted, and the backplane 2 is fixedly connected with the lamp source fixing device 6 on the back of the LED backlight module without being extended to the side of the LED backlight module for being fixed. Therefore, the embodiment can reduce the cost on the one hand, and can reduce the width of the frame of the LCD device on the other hand to accord with the trend of light-weight and thin LCD device. Said front frame 3 and said lamp source fixing device 6 can be fixed by one or more screws 11 and the like.

Said backplane 2 is provided with one or more convex prismatical threaded holes; said lamp source fixing device 6 is provided with one or more via holes matched with said convex prismatical threaded hole; and said lamp source fixing device 6 is fixedly connected with said backplane 2 on one side of said lamp source fixing device 6 by one or more screws via the threaded hole through the via hole. In the fixing mode, because the threaded hole of the backplane 2 is convex, the inner wall of the hole can be provided with more threads, and the screw 11 can be firmly screwed in the threaded hole. Of course, other fixing modes also belong to the protection scope of the present invention.

In the aspect of material, said lamp source fixing device 6 is made of aluminum extrusion. The aluminum extrusion has the advantages of moderate price, light weight, good heat dispersion and high cost performance. The lamp source fixing device 6 made of metal material can also perform the heat dissipation function when effectively fixing the LED 5 light bar.

When the aforementioned LCD device is assembled, the lamp source fixing device 6 is attached to the backplane 2 by S screw 11, and the reflection sheet 71, the LGP, the optical diaphragm 73, and the LCD panel 9 are put in. Then, the front frame 3 is covered, and the front frame 3 is attached to the lamp source fixing device 6 by screw 11. Thus, the whole module is completely assembled. During disassembly, the screw 11 for attaching the front frame 3 is unscrewed, and then the screw 11 for fixing the lamp source fixing device 6 and the backplane 2 is unscrewed. Thus, the whole lamp source fixing device 6 can be taken out.

Embodiment 2.

One end of said lamp source fixing device 6 for fixing the LED 5 light bar is positioned on one side of said LGP 72, and the positioning plate 8 is arranged between the upper part of the end and the LCD panel 9; said positioning plate 8 comprises a first end 81 arranged between the side of the LCD panel 9 and the front frame 3. The clamping force is increased by the positioning plate 8 to said LCD panel 9, and the side of the LCD panel 9 is limited by the first end 81. Preferably, the buffer material 1 can be additionally added onto the surface of the positioning plate 8 which is in contact with said LCD panel 9, and buffer material 1 can also be additionally added between the LCD panel 9 and the LGP 72 to increase the clamping force. The buffer material 1 is added on the side and the bottom of the LCD panel so that preferable clamping force is brought to the LCD panel 9 and the LCD panel 9 is difficult to crush to pieces. In addition, the buffer material 1 added to the bottom of the LCD panel 9 can also perform the function of shading light, reducing the light leakage of LED 5 light source, and further increasing the light incidence rate in addition to increasing the clamping force. Said buffer material 1 can be rubber material and the like which have certain elastic deformation.

Furthermore, said positioning plate 8 also comprises a second end 82 which is arranged between said LED 5 light bar and said LGP 72, and one side of said second end 82 is in contact with the light incident surface of said LGP 72. The second end 82 is butted with the light incident surface of the LGP 72 so that the LED 5 can be prevented from being extruded and damaged when the LGP 72 is expanded by heat. Of course, the surface of said second end 82 which is in contact with said LGP 72 can also be provided with the buffer material 1. The buffer material 1 can buffer the extruding force of the second end 82 to the LGP 72, and reduce the possibility that the LGP 72 is extruded and damaged.

Because the second end 82 is butted with the light incident surface of the LGP 72, the LED 5 can be prevented from being extruded and damaged when the LGP 72 is expanded by heat. Therefore, the LED 5 is in contact with the light incident surface of said LGP 72. Zero light coupling distance is achieved; the light incidence rate of the LGP 72 is maximized; and the light mixing distance of the LED 5 is guaranteed.

The present invention is described in detail in accordance with the above contents with the specific preferred embodiments. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A light emitting diode (LED) backlight module, comprising: a lamp source fixing device for fixing the LED light bar, and a backplane connected with the lamp source fixing device; said lamp source fixing device is positioned on the outermost layer of said LED backlight module and is fixed on the outside of said backplane.

2. The LED backlight module of claim 1, wherein said backplane is provided one or more with convex prismatical threaded holes; said lamp source fixing device is provided with one or more via holes matched with said convex prismatical threaded hole; and said lamp source fixing device is fixedly connected with said backplane on one side of said lamp source fixing device by one or more screws via the threaded hole through the via hole.

3. The LED backlight module of claim 1, wherein said lamp source fixing device is made of aluminum extrusion.

4. A liquid crystal display (LCD) device, comprising: a LCD panel, a backlight module and a front frame for fixing said LCD panel and said backlight module; said backlight module comprises a lamp source fixing device for fixing the LED light bar, and a backplane connected with the lamp source fixing device; said lamp source fixing device is positioned on the outermost layer of said LED backlight module and is fixed on the outside of said backplane.

5. The LCD device of claim 4, wherein said backplane is provided with one or more convex prismatical threaded holes; said lamp source fixing device is provided with one or more via holes matched with said convex prismatical threaded hole; and said lamp source fixing device is fixedly connected with said backplane on one side of said lamp source fixing device by one or more screws via the threaded hole through the via hole.

6. The LCD device of claim 5, wherein said lamp source fixing device is made of aluminum extrusion.

7. The LCD device of claim 4, wherein said front frame is fixedly connected with said lamp source fixing device.

8. The LCD device of claim 5, wherein said front frame is fixedly connected with said lamp source fixing device.

9. The LCD device of claim 6, wherein said front frame is fixedly connected with said lamp source fixing device.

10. The LCD device of claim 4, wherein said LCD device comprises a reflection sheet, a light guide plate (LGP), and an optical diaphragm which are sequentially arranged above said backplane; wherein said LCD panel is positioned above the light emergent surface of the optical diaphragm; one end of said lamp source fixing device for fixing the LED light bar is positioned on one side of said LGP, and the positioning plate is arranged between the upper part of the end and the LCD panel; said positioning plate comprises a first end arranged between the side of the LCD panel and the front frame.

11. The LCD device of claim 5, wherein said LCD device comprises a reflection sheet, a light guide plate (LGP), and an optical diaphragm which are sequentially arranged above said backplane; wherein said LCD panel is positioned above the light emergent surface of the optical diaphragm; one end of said lamp source fixing device for fixing the LED light bar is positioned on one side of said LGP, and the positioning plate is arranged between the upper part of the end and the LCD panel; said positioning plate comprises a first end arranged between the side of the LCD panel and the front frame.

12. The LCD device of claim 6, wherein said LCD device comprises a reflection sheet, a light guide plate (LGP), and an optical diaphragm which are sequentially arranged above said backplane; wherein said LCD panel is positioned above the light emergent surface of the optical diaphragm; one end of said lamp source fixing device for fixing the LED light bar is positioned on one side of said LGP, and the positioning plate is arranged between the upper part of the end and the LCD panel; said positioning plate comprises a first end arranged between the side of the LCD panel and the front frame.

13. The LCD device of claim 10, wherein the surface of said positioning plate which is in contact with said LCD panel is provided with a buffer material.

14. The LCD device of claim 11, wherein the surface of said positioning plate which is in contact with said LCD panel is provided with a buffer material.

15. The LCD device of claim 12, wherein the surface of said positioning plate which is in contact with said LCD panel is provided with a buffer material.

16. The LCD device of claim 10, wherein said positioning plate also comprises a second end which is arranged between said LED light bar and said LGP, and one side of said second end is in contact with the light incident surface of said LGP.

17. The LCD device of claim 11, wherein said positioning plate also comprises a second end which is arranged between said LED light bar and said LGP, and one side of said second end is in contact with the light incident surface of said LGP.

18. The LCD device of claim 12, wherein said positioning plate also comprises a second end which is arranged between said LED light bar and said LGP, and one side of said second end is in contact with the light incident surface of said LGP.

19. The LCD device of claim 16, wherein said LED is in contact with the light incident surface of said LGP.

20. The LCD device of claim 17, wherein said LED is in contact with the light incident surface of said LGP.

21. The LCD device of claim 18, wherein said LED is in contact with the light incident surface of said LGP.

22. The LCD device of claim 10, wherein the surface of said second end which is in contact with said LGP is provided with a buffer material.

23. The LCD device of claim 11, the surface of said second end which is in contact with said LGP is provided with a buffer material.

24. The LCD device of claim 12, wherein the surface of said second end which is in contact with said LGP is provided with a buffer material.
